(19) United States
(12) Patent Application Publication
(10) Pub. No.: US 2014/0017928 A1
(43) Pub. Date: Jan. 16, 2014

(54) LOCKABLE MATING CONNECTOR

(71) Applicants: Syed Sarwar Shah, Carmel, IN (US); Donald Wayne Collier, Mooresville, IN (US)

(72) Inventors: Syed Sarwar Shah, Carmel, IN (US); Donald Wayne Collier, Mooresville, IN (US)

(73) Assignee: Molex Incorporated, Lisle, IL (US)

(21) Appl. No.: 13/981,344

(22) PCT Filed: Feb. 23, 2012
(86) PCT No.: PCT/US12/26319

§ 371 Date: Sep. 11, 2013

Related U.S. Application Data
(60) Provisional application No. 61/445,794, filed on Feb. 23, 2011.

(51) Int. Cl. H01R 13/62

(52) U.S. Cl. CPC H01R 13/62
USPC 439/350

(57) ABSTRACT

A connector includes a housing and a locking member slidably mounted on the housing for movement between a mateable position and a locked position. First and second locking components interact to lock the locking sleeve in a locked position. Each of a plurality of deflectable spring arms includes a latching component for latching to a mating connector. At the locked position, each of the spring arms is secured in a latched position.

### REFERENCE TO RELATED APPLICATIONS

The Present Disclosure claims priority to prior-filed U.S. Provisional Patent Application No. 61/445,794, entitled “Lockable Mating Connector,” filed on 23 Feb. 2012 with the United States Patent And Trademark Office. The content of the aforementioned Patent Application is fully incorporated in its entirety herein.

### BACKGROUND OF THE PRESENT DISCLOSURE

The disclosure relates generally to connectors and, more particularly, to a connector for secure locking to another connector.

When mating connectors to one another, it is often desirable to latch and/or lock such connectors together in order to reduce the likelihood that the connectors will be accidently unmated. A variety of types of latches and locks have been utilized including threaded fasteners, pivotable latches as well as push-pull structures. Most of these latches and locks are either susceptible to unlatching or unlocking or incorporate relatively complex or large latching or locking structures. Accidental unmating may be difficult to prevent when the connectors or cables to which they are terminated are subjected to high “pull out” forces, twisting motions or excessive vibration. In addition, such actions may also damage the latching or locking mechanisms. Accordingly, it is desirable to provide a highly reliable latching and locking mechanism that is capable of withstanding significant pull out forces and twisting motion without causing accidental unmating or damaging the connectors.

The foregoing background discussion is intended solely to aid the reader. It is not intended to limit the innovations described herein nor to limit or expand the prior art discussed. Thus, the foregoing discussion should not be taken to indicate that any particular element of a prior system is unsuitable for use with the innovations described herein, nor is it intended to indicate any element, including solving the motivating problem, to be essential in implementing the innovations described herein. The implementations and application of the innovations described herein are defined by the appended claims.

### SUMMARY OF THE PRESENT DISCLOSURE

An electrical connector for interconnecting to a mating electrical connector along a mating axis includes a body and a locking sleeve. The locking sleeve has a first locking component and is slidably mounted on the body for movement between a mateable position and a locked position. A conductive contact is positioned within the body for mating with a first conductive contact of the mating connector. A generally cylindrical conductive outer contact is positioned for mating with a second conductive contact of the mating electrical connector. The conductive outer contact is generally coaxial with the conductive contact. Each of a plurality of deflectable spring arms includes a latching component for latching the electrical connector. A second locking component is provided for engaging the first locking component of the locking sleeve upon positioning the locking sleeve at the locked position. At the locked position, deflection of the spring arms is prevented by the locking sleeve and the first locking component engages the second locking component to secure the locking sleeve relative to the spring arms.

An electrical connector for interconnecting to a mating electrical connector along a mating axis includes a body and a locking sleeve. The locking sleeve is slidably mounted on the body for movement between a mateable position and a locked position and has a first locking component. A conductive contact is positioned within the body for mating with a first conductive contact of the mating connector. A generally cylindrical conductive outer contact is positioned for mating with a second conductive contact of the mating electrical connector. The conductive outer contact is generally coaxial with the conductive contact. A generally cylindrical latching and locking member has a plurality of deflectable spring arms with each spring arm including a latching component for latching the electrical connector to the mating electrical connector and a second locking component for engaging the first locking component of the locking sleeve upon positioning the locking sleeve at the locked position. Upon positioning the locking sleeve at the locked position, deflection of the spring arms is prevented and the first locking component engages the second locking component to secure the locking sleeve relative to the spring arms.

A connector for mating with a mating connector includes a housing and a locking member slidably mounted on the housing for movement between a mateable position at which the connector is configured to mate with the mating connector and a locked position at which the locking sleeve is locked relative to the housing. The locking member has a first locking component. A coupling member is positioned within the housing for mating with a coupling member of the mating connector. Each of a plurality of deflectable spring arms includes a latching component for latching the connector to the mating connector and a second locking component generally adjacent the latching component for engaging the first locking component of the locking member upon positioning the locking member at the locked position to lock the spring arms in a latched position.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of a plug connector terminated to a cable and aligned with a mating receptacle connector;

FIG. 2 is an exploded perspective view of the plug connector and cable of FIG. 1;

FIG. 3 is a section of the plug and receptacle connectors taken generally along line 3-3 of FIG. 1;

FIG. 4 is a view similar to that of FIG. 3 but enlarged and with only some components depicted in section for clarity;

FIG. 5 is a section similar to FIG. 3 but enlarged and with the plug connector and receptacle connector mated together and with the locking sleeve in its mateable position;

FIG. 6 is a view similar to that of FIG. 5 but with only some components depicted in section for clarity;

FIG. 7 is a section similar to FIG. 5 but with the plug connector and receptacle connector mated together and with the locking sleeve in its locked position; and

FIG. 8 is a view similar to that of FIG. 7 but with only some components depicted in section for clarity.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the disclosure is to be considered an exemplification of the principles of the Present Disclosure, and is not intended to limit the Present Disclosure to that as illustrated.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

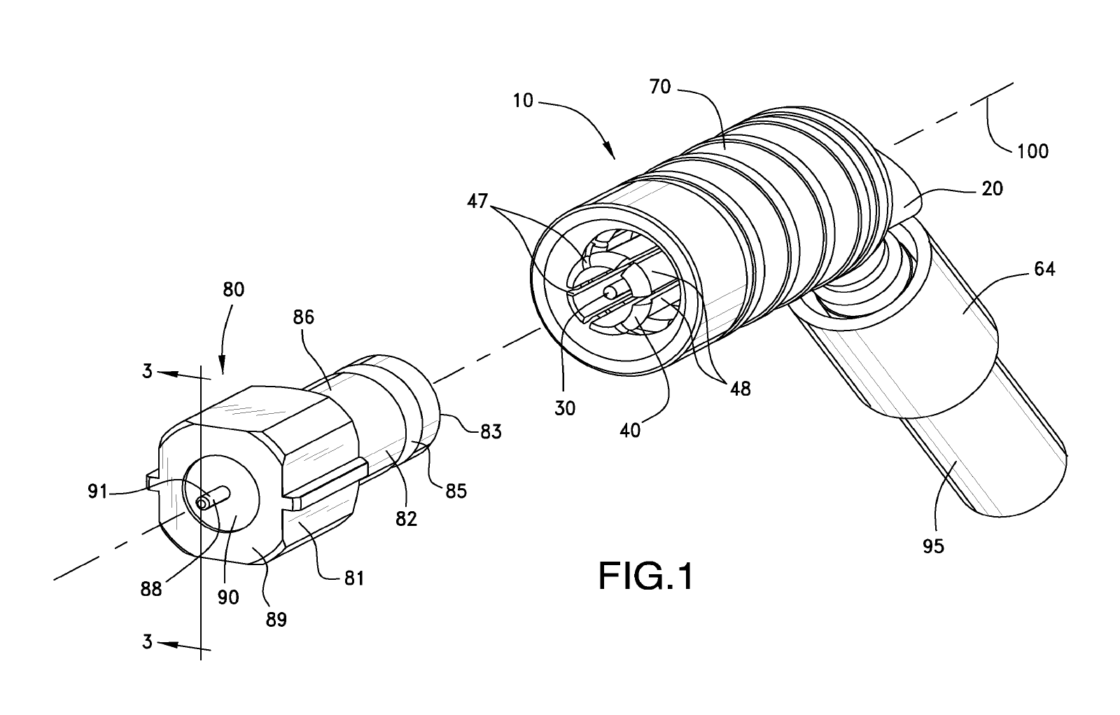

FIG. 1 depicts a plug connector 10 aligned for mating with a receptacle connector 80 along a central or mating axis 100. Plug connector 10 includes an angled housing or body 20 having a central signal contact 30 and an outer contact 40 surrounding the central signal contract. A locking member or sleeve 70 is slidably mounted on plug connector 10 for locking plug connector 10 with receptacle connector 80. Central signal contact 30 and outer contact 40 are both electrically connected to cable 95.

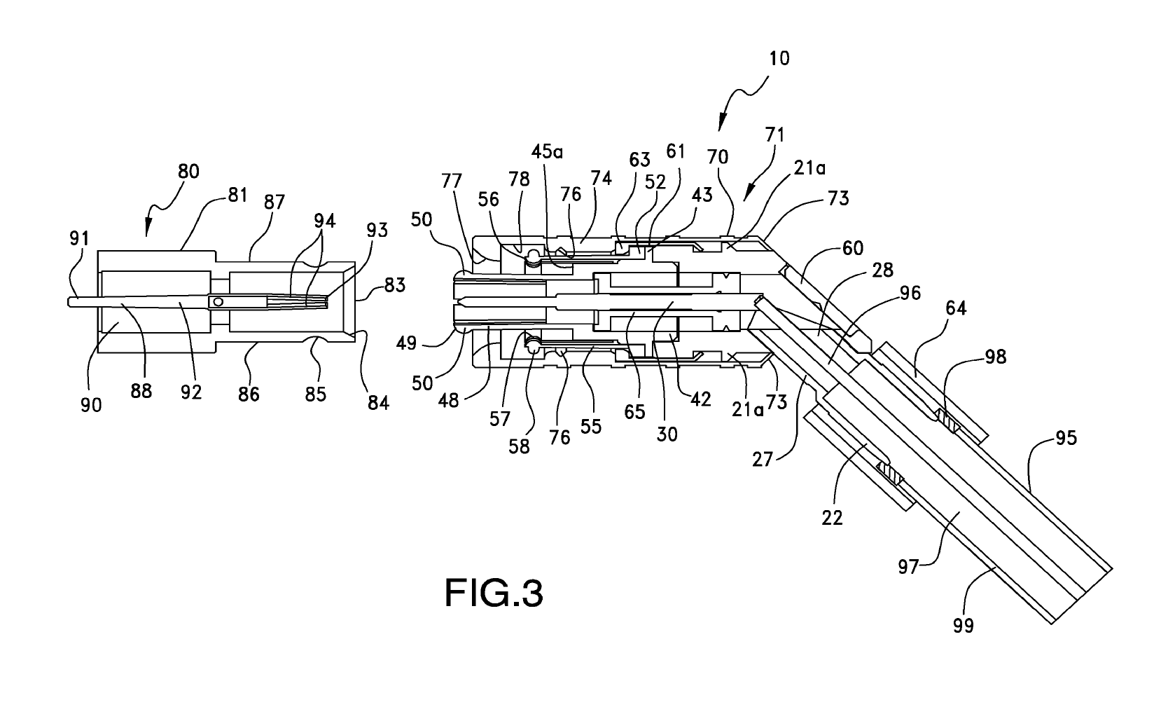

Receptacle connector 80 includes a conductive housing or body 81 with a forwardly projecting (to the right in FIGS. 3-8) cylindrical outer contact 82. The outer contact 82 has a mating end 83 with a tapered opening 84 (FIG. 3). An annular latching groove or recess 85 is located on the outer surface 86 of cylindrical outer contact 82 generally adjacent the mating end 83 in order to facilitate latching of the receptacle connector 80 to plug connector 10. A board mountable center contact 88 within receptacle connector 80 extends from a board mounting end 89 to the mating end 83. A dielectric insert or insulator 90 is positioned between housing 81 and center contact 88 in order to electrically insulate the center contact from the housing. Center contact 88 includes a tail 91 for making an electrical connection to a circuit board (not shown) such as by soldering, a body section 92 extending through insulator 90 and a mating end 93 with spring arms or deflectable beams 94 for mating with central signal contact 30 of plug connector 10.

It should be noted that in this description, representations of directions such as up, down, left, right, front, rear, and the like, used for explaining the structure and movement of each part of the disclosed embodiment are not intended to be absolute, but rather are relative. These representations are appropriate when each part of the disclosed embodiment is in the position shown in the figures. If the position or frame of reference of the disclosed embodiment changes, however, these representations are to be changed according to the change in the position or frame of reference of the disclosed embodiment.

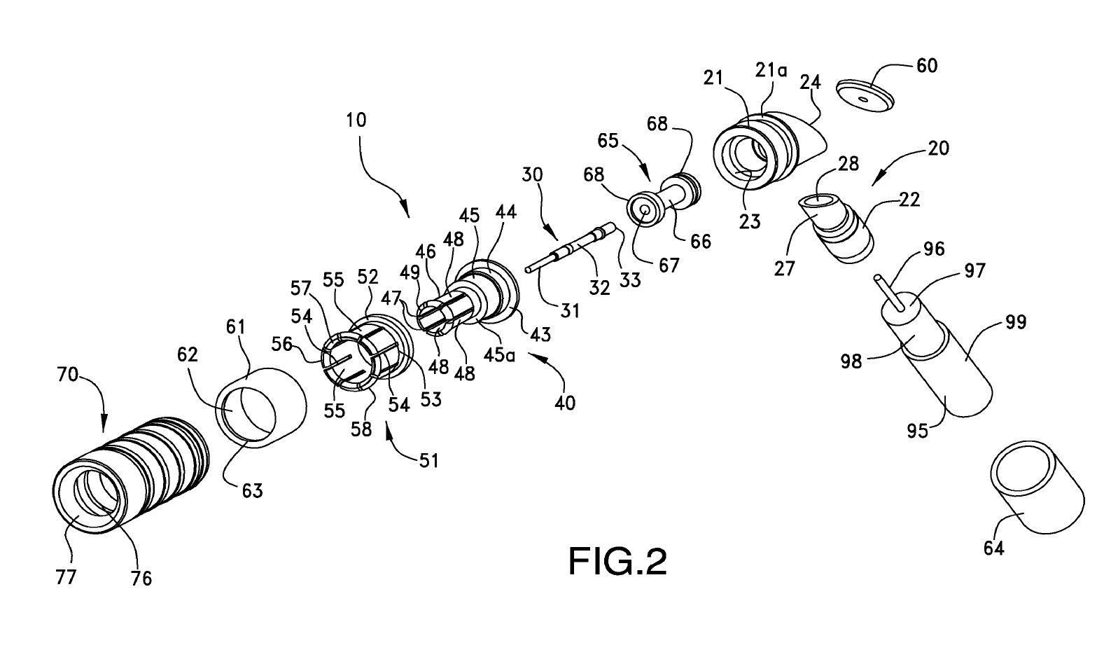

Referring to FIGS. 2-3, angled housing 20 includes a main body section 21 and a cable receiving rear body section 22. Main body section 21 is generally cylindrical with a hollow bore 23 and an angled rear surface 24 having an opening 25 for providing access to the termination end 33 of central signal contact 30. An annular projection 21a extends from an outer surface of main body section 21 to define a forward limit of movement of sleeve 70 on plug connector 10. A generally disk-shaped cap or cover 60 is dimensioned to seal the opening 25 in main body section 21. Main body section 21 further includes an opening 26 in its lower surface adjacent rear opening 25 for receiving an upper section 27 of cable receiving rear body section 22. Cable receiving rear body section 22 has a hollow bore 28 for receiving cable 95 therein. Both the main body section 21 and the cable receiving rear body section 22 may be formed of a conductive material such as brass or any other material that will provide similar functionality.

Central signal contact 30 is positioned within angled housing 20 along the mating axis 100 of plug connector 10. Central signal contact 30 has a mating end 31, a body section 32 and a rear termination end 33. Rear termination end 33 may include a structure for electrically connecting to an end of center conductor 96 of cable 95 such as a recess 34 that may be soldered or otherwise terminated to the center conductor. Central signal contact 30 may be formed of a conductive material such as brass or any other material that will provide similar functionality.

Outer contact 40 is generally cylindrical with a bore therein and includes a base 42 (FIG. 3), a flange 43, a first body section 44 having a smaller diameter than flange 43 and a second body section 45. Base 42 is dimensioned to be received within bore 23 of main body section 21 and flange 43 engages the forward end of the main body section in order to position outer contact 40 relative to the main body section. A generally cylindrical barrel 46 extends forwardly (to the left in FIGS. 3-8) from second body section 45 and has a plurality of a longitudinally extending slots 47 spaced therearound to define a plurality of spring arms or deflectable beams 48 that form the annular mating interface of outer contact 40. The forwardly facing end surface 45a of second body section 45 and its interaction with the mating end 83 of center contact 82 define the mating depth between plug connector 10 and receptacle connector 80. The end 49 of each spring arm 48 has an outwardly projecting arcuate ridge or outer projection 50 to define a generally annular ridge or projection for engaging an inner surface 87 of the outer contact 82 of receptacle connector 80. The outer contact 40 may be made of a conductive material such as a beryllium copper or any other material that will provide similar functionality.

Latching and locking member 51 is generally cylindrical and has a bore therein with a flange 52 at one end and a generally cylindrical barrel 53 extending forwardly from the flange.

Barrel 53 has a plurality of longitudinally extending slots 54 spaced therearound to define a plurality of spring arms or deflectable beams 55. The end 56 of each spring arm 55 includes an inwardly projecting arcuate ridge or inner latching projection 57 to define a generally annular ridge or projection for engaging annular latching groove 85 of the outer contact 82 of receptacle connector 80. The end 56 of each spring arm 55 further includes an outwardly projecting arcuate ridge or outer locking projection 58 to define a generally annular ridge or projection for engaging v-shaped annular locking groove 76 of sleeve 70.

Flange 52 has an outer diameter generally equal to that of flange 43 of outer contact 40 and an inner diameter dimensioned to be received by first body section 44 of the outer contact. Referring to FIG. 3, it can be seen that latching and locking member 51 is slid onto the first body section 44 of outer contact 40 until the flange 52 of the latching and locking member engages the flange 43 of the outer contact. Second body section 45 of outer contact 40 is dimensioned so as to permit the spring arms 55 of latching and locking member 51 to deflect inwardly without engaging or being impeded by the outer contact. The latching and locking member 51 may be made of a conductive material such as a beryllium copper or any other material that will provide similar functionality.

Dielectric insert or insulator 65 electrically isolates central signal contact 30 from angled housing 20 and outer contact 40 while maintaining a desired impedance through the connector. Insulator 65 has a generally cylindrical body 66 with a bore 67 through which central signal contact 30 extends. Enlarged circular end portions 38 provide the desired spacing between central signal contact 30 and angled housing 20 and outer contact 40. The insulator 65 may be formed of a rigid or semi-rigid insulator such as polytetrafluoroethylene or any other material that will provide similar functionality.

A generally cylindrical retention member or cap 61 includes a hollow bore 62 together with a flange 63 at the forward end thereof. Retention cap 61 is configured to be secured to main body section 21 of angled housing 20, such as by rolling or otherwise deforming the end thereof. The outer contact 40 and the latching and locking member 51 extend through the bore 62 and the flange 63 engages flange 52 of the latching and locking member to retain the outer contact and the latching and locking member to the main body section 21. Retention cap 61 may be formed of a conductive material such as stainless steel, CRES alloy or any other material that will provide similar functionality.

Generally cylindrical locking member or sleeve 70 is positioned for sliding movement on main body section 21. Sleeve 70 includes a hollow bore with a rear section 71 having an inner diameter 72 slightly larger than that of the outer diameter of main body section 21 and retention cap 61 so that sleeve 70 may slide thereon. Rear section 71 has a reduced diameter projection 73, formed such as by rolling or otherwise deforming the end thereof, that acts as a rear wall or stop to define the forward (to the right in FIGS. 3-8) limit of travel of sleeve 70 relative to housing 20. Sleeve 70 includes a central section 74 having a smaller diameter than rear section 71 to define a forward wall or stop 75 at the intersection of the rear section 71 and central section 74 to define the rearward limit of travel of sleeve 70 relative to plug connector 10. Central section 74 includes a generally v-shaped annular locking groove 76 dimensioned to receive the outer locking projections 58 of spring arms 55 of latching and locking member 51.

Locking sleeve 70 includes a tapered mating end 77 to facilitate mating of plug connector 10 with receptacle connector 80 and guide outer contact 82 of receptacle connector 80 between the spring arms 48 of outer contact 40 and spring arms 55 of latching and locking member 51 during the mating process. An enlarged diameter section 78 is located between the central section 74 and the tapered mating end 77 and is dimensioned to permit spring arms 55 of latching and locking member 51 to deflect therein during the mating process. More specifically, as the inner latching projection 57 of each spring arm 55 of latching and locking member 51 engages the leading edge of the cylindrical outer contact 82 of receptacle connector 80, the spring arms will be deflected outwardly and remain deflected until the inner latching projections 57 are received within annular latching groove 85 of receptacle connector 80. Enlarged diameter section 78 is dimensioned so that the outer locking projections 58 do not contact the enlarged diameter section and thus do not impede the movement of spring arms 55 during the mating process.

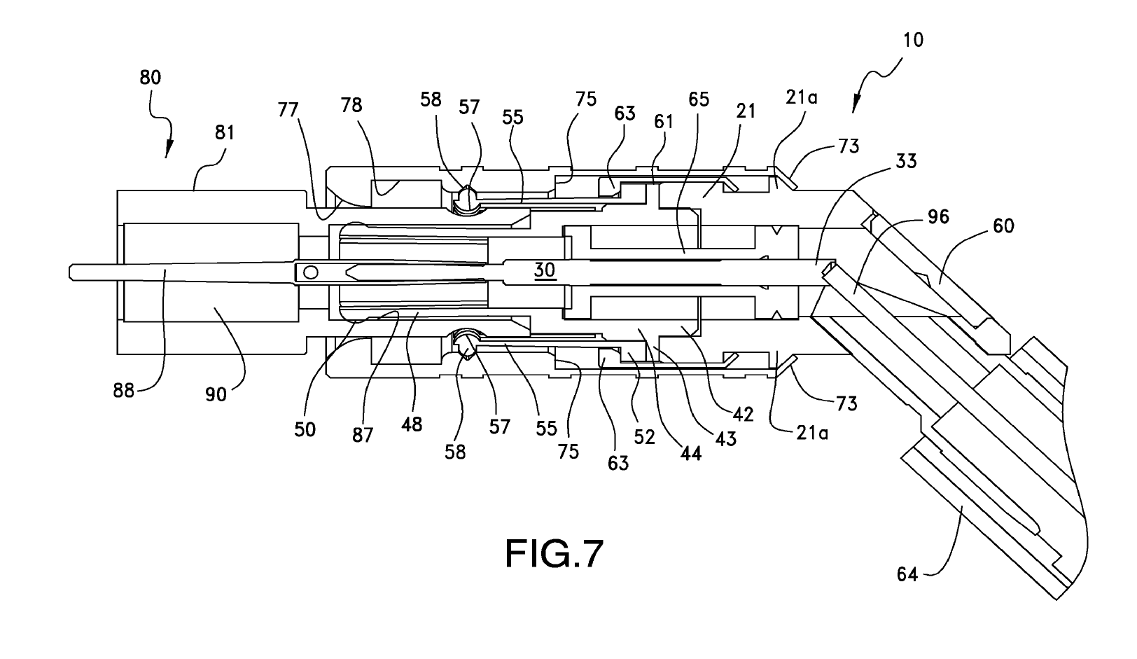

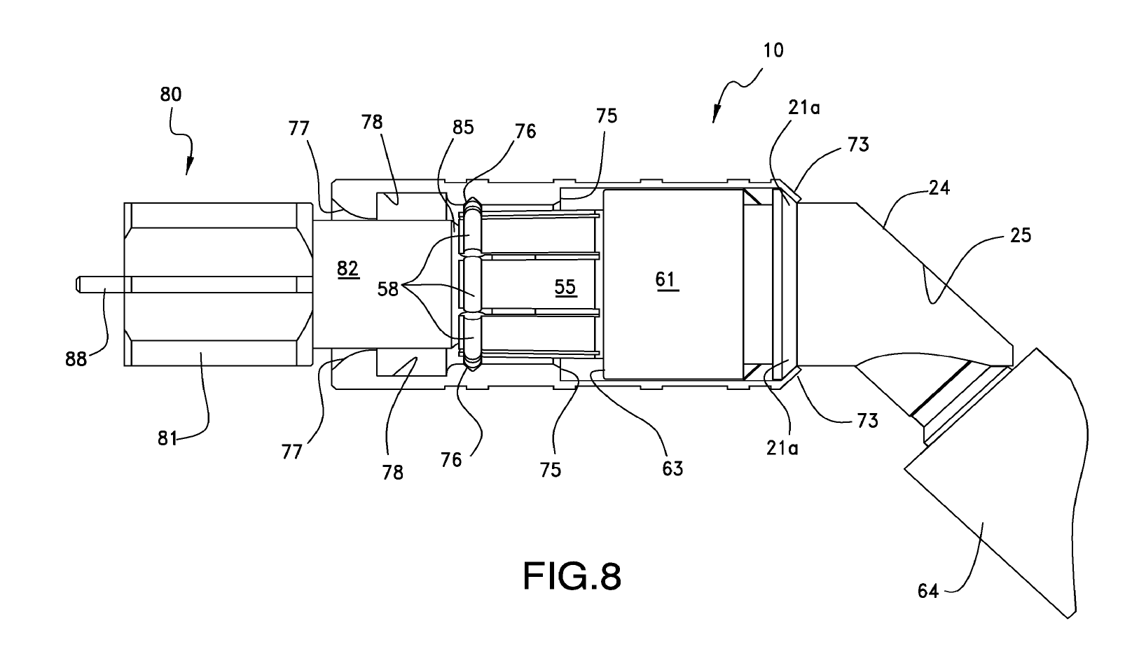

Through such a configuration, sleeve 70 is movable along mating axis 100 between a first mateable position, depicted in FIGS. 3-6, and a second locked position, depicted in FIGS. 7-8. At the first mateable position, annular projection 21a of main body section 21 engages reduced diameter projection 73 of sleeve 70, forward stop 75 of sleeve 70 is spaced from flange 63 of retention cap 61 and outer locking projections 58 of spring arms 55 are aligned with enlarged diameter section 78 of sleeve 70 in order to permit the spring arms to deflect outwardly during the process of mating plug connector 10 to receptacle connector 80. At the second locked position, sleeve 70 is slid rearwardly (to the right in FIGS. 3-8) and annular projection 21a of main body section 21 is spaced from the reduced diameter projection 73 of sleeve 70, flange 63 of retention cap 61 is adjacent forward stop 75 of the sleeve and outer locking projections 58 of spring arms 55 are positioned within v-shaped annular locking groove 76 of the sleeve. Locking sleeve 70 may be formed of a material such as stainless steel, CRES alloy or any other material that will provide similar functionality.

Coaxial cable 95 includes a center conductor 96 and an insulator 97 surrounding the center conductor together with a conductive outer shield or braid 98 extending along the outer surface of the insulator. An outer insulator or jacket 99 surrounds the outer shield 98.

Upon terminating the coaxial cable 95 to plug connector 10, center conductor 96 is terminated to the rear termination end 33 of central signal contact 30 such as by soldering and the conductive outer shield 98 is terminated to the cable receiving rear body section 22 such as by crimping with conductive crimp tube 64 engaging both the cable receiving rear body section 22 and the conductive outer shield. After center conductor 96 is terminated to rear termination end 33 of central signal conductor 31, cap 60 may be secured to main body section 21 in order to close opening 25 at the angled rear surface thereof.

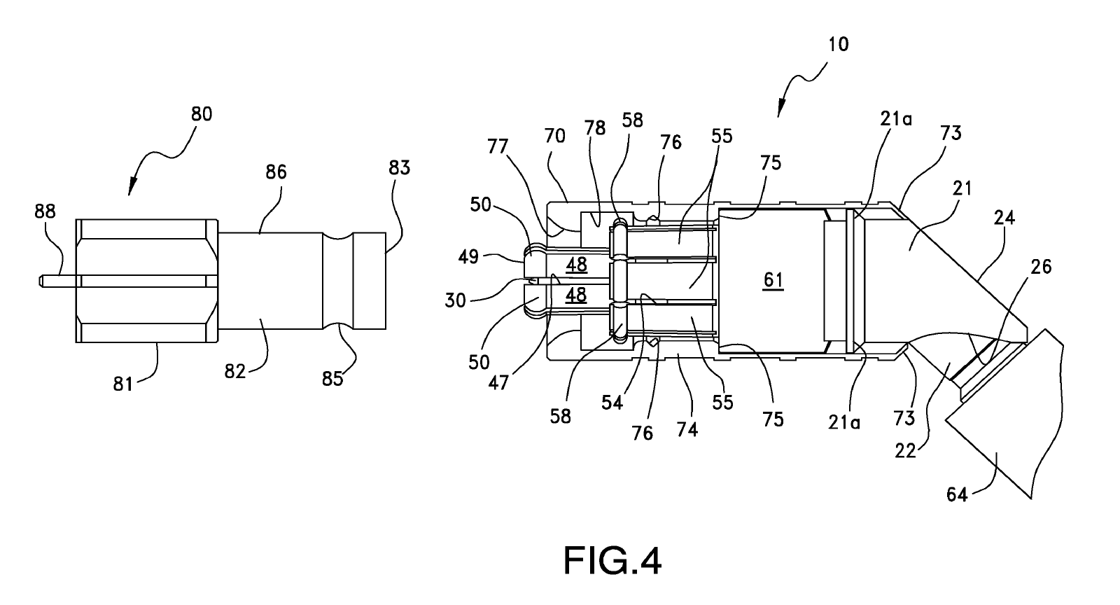

The sequence of mating and locking plug connector 10 and receptacle connector 80 is depicted in FIGS. 3-8. Referring first to FIGS. 3-4, the plug connector 10 and receptacle connector 80 are aligned along mating axis 100 in preparation for mating. Sleeve 70 is in its first mateable position with the annular projection 21a of main body section 21 adjacent reduced diameter projection 73 of sleeve 70, flange 63 of retention cap 61 is spaced from forward stop 75 of the sleeve and outer locking projections 58 of spring arms 55 are aligned with enlarged diameter section 78 of the sleeve.

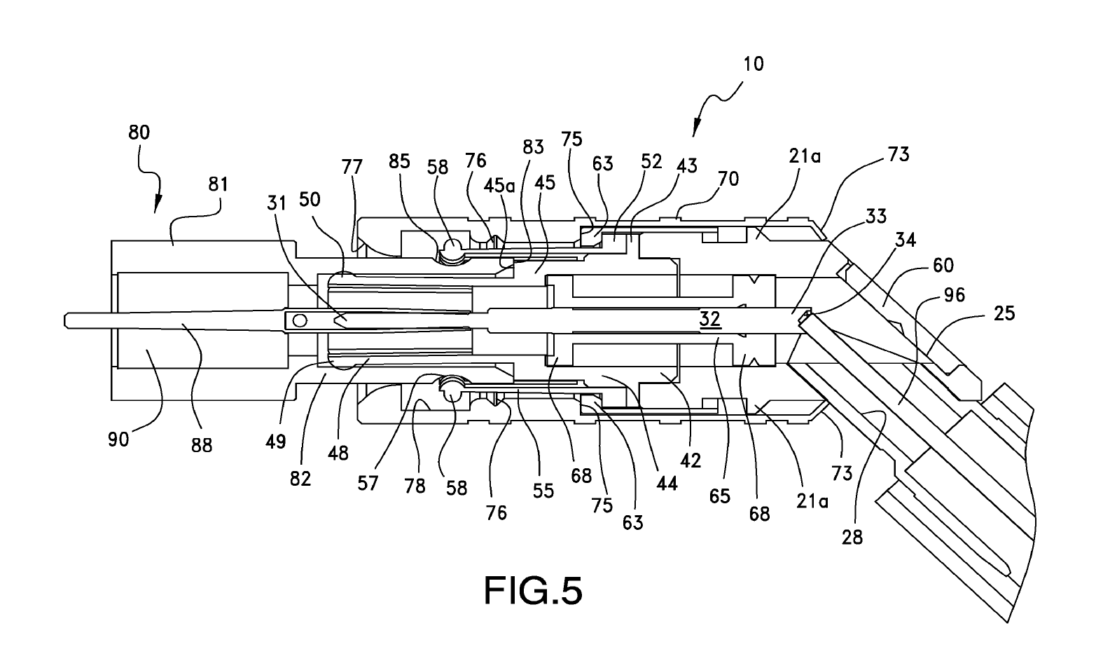

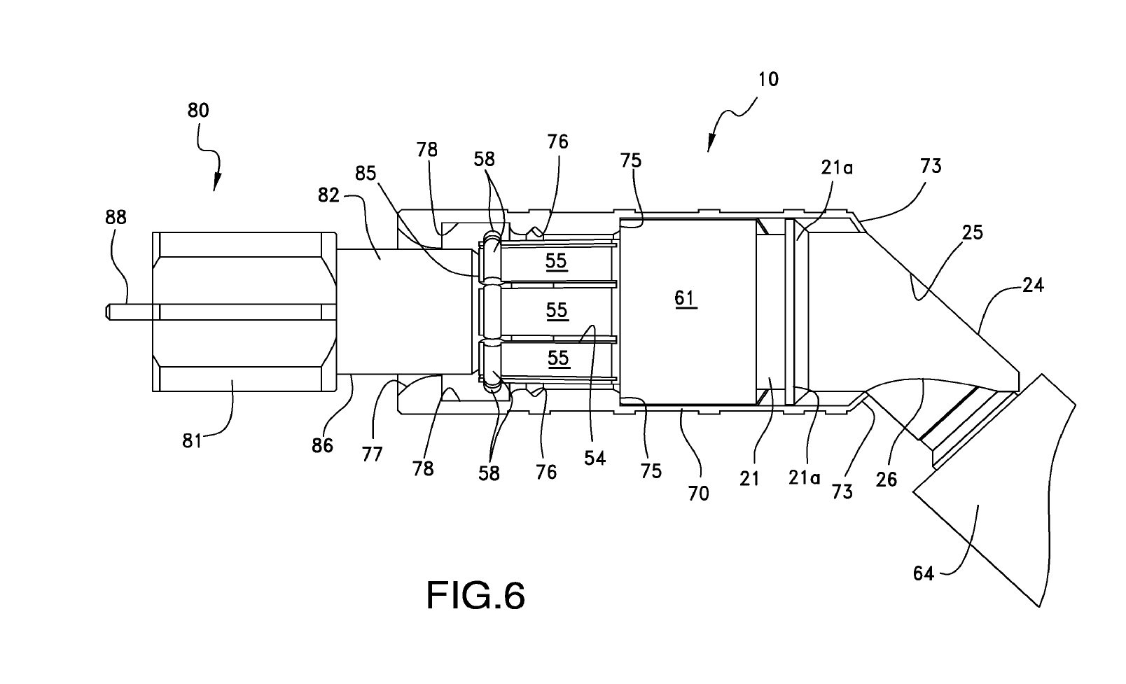

Upon mating plug connector 10 and receptacle connector 80 as shown in FIGS. 5-6, the mating end 31 of central signal contact 30 engages and deflects spring arms 94 of center contact 88 to form an electrical connection between the central signal contact 30 and the center contact 88. In addition, the outer projections 50 of spring arms 48 of outer contact 40 engage the inner surface 87 of cylindrical outer contact 82 to form an electrical connection between the inner contact 40 and the cylindrical outer contact 82. During the mating process, inner latching projections 57 of spring arms 55 of latching and locking member 51 engage the outer surface 86 of cylindrical outer contact 82 and deflect the spring arms 55 outward so that the outer locking projections 58 approach enlarged diameter section 78 of sleeve 70. Inner latching projections 57 of spring arms 55 of the latching and locking member 51 slide along the outer surface 86 of the cylindrical outer contact 82 until they reach annular latching groove 85 at which point the resiliency of spring arms 55 forces the inner latching projections 57 into annular latching groove 85. The forwardly facing end surface 45a of second body section 45 and its interaction with the mating end 83 of center contact 82 define the mating depth between plug connector 10 and receptacle connector 80.

Referring to FIGS. 7-8, sleeve 70 is then slid from its first mateable position to its second locked position (to the left in FIGS. 3-8) in order to securely lock the plug connector 10 to the receptacle connector 80 so as to minimize their likelihood of unintended unmating of the two connectors. More specifically, it can be seen that sleeve 70 is positioned relative to plug connector 10 such that annular projection 21a of main body section 21 is spaced from the reduced diameter projection 73 of sleeve 70, flange 63 of retention cap 61 is adjacent forward stop 75 of the sleeve and outer locking projections 58 of spring arms 55 are positioned within v-shaped annular locking groove 76 of the locking sleeve. As best seen in FIG. 7, it can be seen that the end 56 of each spring arm 55 together with the oppositely facing inner latching projections 57 and outer locking projections 58 are sandwiched between the annular latching groove 85 of the cylindrical outer contact 82 and the v-shaped annular locking groove 76 of locking sleeve 70. Through such a configuration, plug connector 10 and receptacle connector 80 are securely locked together. Until the locking sleeve is returned to its first mateable position, unmating of the two connectors will be resisted even if force is applied in an attempt to pull the two connectors apart or if the connectors are rotated relative to each other or the locking sleeve is rotated.

In one example of plug connector 10, approximate dimensions are as follows: the diameter of main body section 21 is about 0.23 in. and the length is about 0.40 in.; the diameter of the mating end 31 of central signal contact 30 is about 0.02 in. and the overall length of the central signal contact 30 is about 0.56 in.; the diameter of the cylindrical barrel 46 of outer contact 40 is about 0.11 in and has a length of about 0.22 in.; the diameter of the cylindrical barrel 53 of latching and locking member 51 is about 0.18 in. and has a length of about 0.19 in.; the thickness of the spring arms 55 is about 0.01 in and the length of the outer locking projections 58 thereon is about 0.01 in.; and the outer diameter of locking sleeve is about 0.26 in.

and has a length of about 0.55 in. In testing utilizing a connector having dimensions described above, the connector was latched and locked to a mating connector and was able to withstand a pull-out force of 100 lbs. without unmating or damaging either connector.

Although the spring arms 55 are shown with the inner latching projections 57 extending inwardly and outer locking projection extending outwardly, alternate latching and locking components could be utilized. For example, rather than the inner latching projections 57 and the annular latching groove 85 on the receptacle connector 80, the spring arms 55 could be formed with inwardly facing latching recesses and the receptacle formed with an annular projection around the cylindrical outer contact 82. Similarly, the outer locking projections 58 on spring arms 55 could be formed as locking recesses and the v-shaped annular locking groove 76 on sleeve 70 replaced with a locking projection that engages such locking recesses. In making such a change, the projection on the locking sleeve 70 would need to be dimensioned and positioned so as not to interfere with the deflection of spring arms 55. In addition, although both the latching and locking functionality are provided at the ends 56 of spring arms 55, the latching and locking functionality could be spaced apart along the mating axis 100. For example, the inner latching projections 57 and the inner surface of central section 74 of sleeve 70 modified so that the outer surface of the end 56 of each spring arm engages a flat inner surface of the central section (i.e., without the v-shaped annular locking groove 76) to prevent spring arms 55 from deflecting outward and unlatching plug connector 10 from receptacle connector 80. With such a modified structure, another mechanism for locking the sleeve 70 at its second locked position would be utilized. In one example, one or more spring arms could be formed in retention cap 61 or an annular projection located on an outer surface thereof that will engage a locking groove (similar to the v-shaped annular locking groove 76) positioned along rear section 71 of sleeve 70 so as to be aligned with the spring arms or annular projection on retention cap 61 when sleeve 70 is in its second locked position. In addition, the amount of force required to slide sleeve 70 on plug connector 10 as well as the plug connector's ability to remain locked can be modified by altering the length and thickness of the spring arms 55, the length and shape of the inner latching projections 57 and the outer locking projections 58, and the depth and shape of the v-shaped annular locking groove 76 and the annular latching groove 85. Still further, the required force could also be reduced by eliminating the outer locking projection 58 from some of the spring arms 55.

While a preferred embodiment of the Present Disclosure is shown and described, it is envisioned that those skilled in the art may devise various modifications without departing from the spirit and scope of the foregoing Description and the appended Claims. For example, the illustrated embodiments could be utilized with electrical connectors having other configurations such as a plurality of electrical contacts with or without a conductive outer contact. In addition, the illustrated embodiments could be utilized to interconnect other types of connectors such as those for optical fibers or fluid transmission. In such case, the electrically conductive contacts would be replaced by coupling members specific to the type of connections being made (e.g., optical fiber ferrules or fluid interconnects).

What is claimed is:

1. An electrical connector for interconnecting to a mating electrical connector along a mating axis, comprising:
a body;
a locking sleeve, the locking sleeve being slidably mounted on the body for movement between a mateable position and a locked position, and comprising a first locking component;
a conductive contact, the conductive contact being disposed within the body for mating with a first conductive contact of the mating electrical connector;
a generally cylindrical conductive outer contact, the conductive outer contact mating with a second conductive contact of the mating electrical connector and being generally coaxial with the conductive contact;
a plurality of deflectable spring arms, each spring arm comprising a latching component, the latching component latching the electrical connector to the mating electrical connector; and
a second locking component, the second locking component engaging the first locking component upon positioning the locking sleeve at the locked position to secure the locking sleeve at the locked position;
wherein:
at the locked position, deflection of the spring arms is prevented by the locking sleeve; and
the first locking component engages the second locking component to secure the locking sleeve relative to the spring arms.

2. The electrical connector of claim 1, wherein the body is electrically conductive.

3. The electrical connector of claim 2, wherein the body is electrically connected to the conductive outer contact.

4. The electrical connector of claim 1, wherein the second locking component is generally aligned along the mating axis with the latching component.

5. The electrical connector of claim 4, wherein the second locking component is positioned on one of the spring arms.

6. The electrical connector of claim 1, wherein the conductive outer contact comprises a plurality of longitudinal slots, each longitudinal slot defining a plurality of deflectable contact beams of the conductive outer contact.

7. The electrical connector of claim 1, wherein the latching component comprises a latching projection, the latching projecting latching to a recess of the mating electrical connector.

8. The electrical connector of claim 1, wherein the first locking component comprises an annular groove, the annular grove being disposed along an inner surface of the locking sleeve.

9. The electrical connector of claim 1, wherein the first locking component comprises a recess.

10. The electrical connector of claim 9, wherein the second locking component comprises a projection.

11. The electrical connector of claim 10, wherein the projection is disposed on each deflectable spring arm and extends radially outward.

12. The electrical connector of claim 1, further comprising a generally cylindrical latching and locking member with the spring arms extending therearound and the conductive outer contact extends therethrough.

13. An electrical connector for interconnecting to a mating electrical connector along a mating axis, comprising:
a body;
a locking sleeve, the locking sleeve being slidably mounted on the body for movement between a mateable position and a locked position, and comprising a first locking component;
a conductive contact, the conductive contact being disposed within the body for mating with a first conductive contact of the mating electrical connector;
a generally cylindrical conductive outer contact, the conductive outer contact mating with a second conductive contact of the mating electrical connector and being generally coaxial with the conductive contact; and
a generally cylindrical latching and locking member, the latching and locking member having a plurality of deflectable spring arms, each spring arm comprising a latching component, the latching component latching the electrical connector to the mating electrical connector, and a second locking component, the second locking component engaging the first locking component of the locking sleeve upon positioning the locking sleeve at the locked position;
wherein:
upon positioning the locking sleeve at the locked position, deflection of the spring arms is prevented; and
the first locking component engages the second locking component to secure the locking sleeve relative to the spring arms.

14. The electrical connector of claim 13, wherein the first locking component includes a recess.

15. The electrical connector of claim 14, wherein the second locking component includes a projection.

16. The electrical connector of claim 13, wherein the locking sleeve, the conductive contact, the conductive center contact and the latching and locking member are all coaxially positioned along the mating axis.

17. A connector for mating with a mating connector, comprising:
a housing;
a locking member, the locking member being slidably mounted on the housing for movement between a mateable position, at which the connector is configured to mate with the mating connector, and a locked position, at which the locking sleeve is locked relative to the housing, the locking member comprising a first locking component;
a coupling member, the coupling member being disposed within the housing for mating with a conductive contact of the mating electrical connector; and
a plurality of deflectable spring arms, each spring arm including a latching component, the latching component latching the connector to the mating electrical connector, and a second locking component, the second locking component disposed generally adjacent the latching component for engaging the first locking component upon positioning the locking member at the locked position to lock the spring arms in a latched position.

18. The connector of claim 17, wherein the housing is conductive.

19. The connector of claim 17, wherein the latching component is aligned along a mating axis of the electrical connector.

20. The connector of claim 18, wherein the the second locking component is aligned along a mating axis of the electrical connector.

21. The connector of claim 17, wherein the first locking component comprises an annular groove along an inner surface of the locking sleeve.

22. The connector of claim 17, wherein the first locking component comprises a recess.

23. The connector of claim 22, wherein the second locking component includes a projection.

24. The connector of claim 17, further comprising a generally cylindrical conductive outer contact, the conductive outer contact mating with a second conductive contact of the mating electrical connector, and being generally coaxial with the coupling member.

25. The connector of claim 24, further comprising a generally cylindrical latching and locking member with the spring arms extending therearound and the conductive outer contact extends therethrough.
